(19) United States
(12) Patent Application Publication
(10) Pub. No.: US 2010/0153912 A1
(43) Pub. Date: Jun. 17, 2010

(54) Variable type knowledge based call specialization

(75) Inventors: Victor Leonel Hernandez Porras, San Francisco, CA (US); Roger Scott Hoover, Cheyenne, WY (US); Eric Marshall Christopher, Los Gatos, CA (US); Christopher Arthur Lattner, San Jose, CA (US); Thomas John O'Brien, San Jose, CA (US); Pratik Solanki, Mountain View, CA (US); Jia-Hong Chen, Cupertino, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/316,768

(22) Filed: Dec. 15, 2008

(51) Int. Cl. G06F 9/44

(52) U.S. Cl. 717/106

(57) ABSTRACT

Variable type knowledge based call specialization is disclosed. An indication is received that a variable that is an argument of a function or operation the behavior of which depends at least in part on a data type of the argument is of a first data type. Machine code that implements a first behavior that corresponds to the first data type, but not a second behavior that corresponds to a second data type other than the first data type, is generated for the function or operation.

### BACKGROUND OF THE INVENTION

In certain programming languages that are not strongly typed, i.e., a variable is not constrained to have associated with it only one clearly defined type of data, such as a character, string, integer, floating point number, and/or Boolean value, a function or operation may have associated with it a first behavior if a variable that is an argument of the function is of a first data type and a second behavior if the variable is instead of a second data type. For example, in JavaScript, which is not strongly typed, the “+” operator when applied to two numbers results in the numbers being summed whereas if the operator is applied to two strings the strings are concatenated. That is, in JavaScript 2+3 yields 5, the sum of the numbers 2 and 3, whereas “two”+“three” yields “twothree”, i.e., the two strings concatenated together. In JavaScript, the “+” operator may be used within the definition of a function, e.g., function b(m,n) {return m+n}, and the operator will result in the arguments being summed if they are numbers or concatenated if they are strings, for example, as determined dynamically at runtime. “Length” is another example of a function or operation that in JavaScript exhibits variable type dependent behavior. The statement “x.length” in JavaScript results in a first behavior if the variable x is a string and a second behavior that is different from the first if the variable x is not a string, e.g., an array.

FIG. 1 is a block diagram illustrating an embodiment of a system for compiling into machine code JavaScript or other code written in a traditionally interpreted programming language. In the example shown, JavaScript 102 is compiled by a compiler 104 to generate compiled machine code 106. In some cases, JavaScript or other traditionally interpreted code may be compiled into machine code to improve performance by providing machine code that is executable directly by a CPU or other processor. Such compiled code may be configured to run in a strongly typed environment. Traditionally, for functions or operations whose behavior varies based on data type in the source programming language, e.g., JavaScript, machine code has been generated to determine at runtime the data type of the value(s) on which the function or operation is to be performed and to cause machine code that provides the version of the behavior that is appropriate to the determined data type to be invoked.

FIG. 2 is a flow diagram illustrating an embodiment of a process for generating machine code. In the example shown, JavaScript (or similar loosely typed or un-typed code) to be compiled is received (202). Instances of invocation of a function or operation whose behavior varies depending on the data type of one or more arguments are detected (204). For each such instance, machine code is generated to determine via conditional statements, dynamically at run time, the data type of the values on which the function or operation is to be performed and to cause machine code configured to provide the behavior that corresponds to the determined data type to be invoked (206).

### BRIEF DESCRIPTION OF THE DRAWINGS

Various embodiments of the invention are disclosed in the following detailed description and the accompanying drawings.

FIG. 1 is a block diagram illustrating an embodiment of a system for compiling into machine code JavaScript or other code written in a traditionally interpreted programming language.

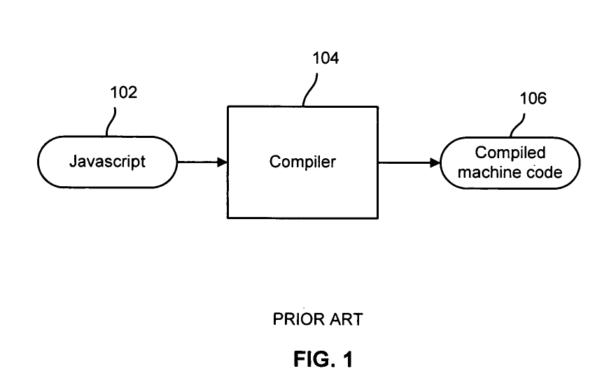

FIG. 2 is a flow diagram illustrating an embodiment of a process for generating machine code.

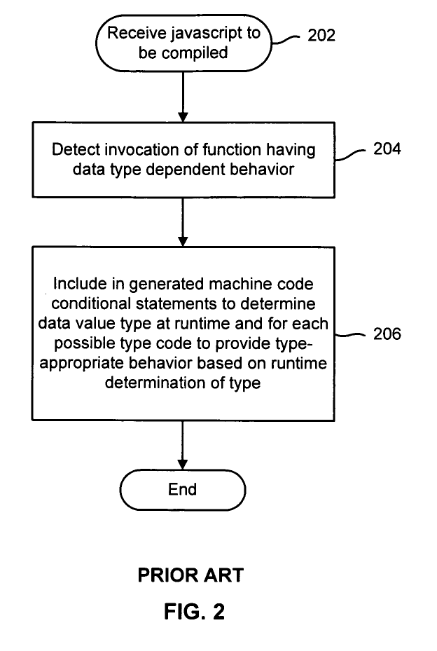

FIG. 3 is a flow diagram illustrating an embodiment of a process for variable type knowledge based call specialization.

FIG. 4 is a block diagram illustrating an embodiment of a system for compiling JavaScript or other code written in a loosely-typed or un-typed programming language.

FIG. 5 is a flow diagram illustrating an embodiment of a process for variable type knowledge based call specialization based on analysis of a byte code or other intermediate representation.

FIG. 6 is a flow diagram illustrating an embodiment of a process for variable type knowledge based call specialization based on observation of source code executed using an interpreter.

FIG. 7 is a block diagram of a computer system 706 used in some embodiments to perform variable type knowledge based call specialization.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Variable type knowledge based call specialization is disclosed. In some embodiments, during compilation of code written in a loosely typed or un-typed programming language, such as JavaScript, where the behavior of one or more operations or functions varies based on the data type of one or more arguments on which the operation or function operates, a determination is made as to which one or more data types actually are or would be encountered in the course of execution of the associated code. For each such data type, code corresponding to a behavior associated with a data type determined to be associated with the argument(s) at a call site at which the operation or function is invoked is generated. For example, in the example described above, in some embodiments in the case of a “+” operator used in JavaScript, for example in a function definition, a determination is made as to the data type(s) of the arguments of the operation at the call site, i.e., the portion of the code at which the “+” operator is invoked. If, for example, analysis of the source code or an intermediate representation thereof, such as LLVM intermediate representation (IR) or bytecode, indicates that the data type of the arguments (e.g., variables) to which the operator is to be applied will be one or the other of a number and a string, machine (or intermediate) code is generated only for the behavior corresponding to data of that type, for example summing if it is determined the variables will always be numbers or concatenating if it is determined that the variables will always be strings. In some embodiments, the data type is determined based on an analysis of the source code and/or an intermediate representation thereof, such as LLVM IR, bytecode, or another similar representation. In some embodiments, the determination is made by observing the JavaScript or other code as executed by an interpreter and noting the data type of the variables and/or the type-dependent behavior of the operator or function as observed at runtime.

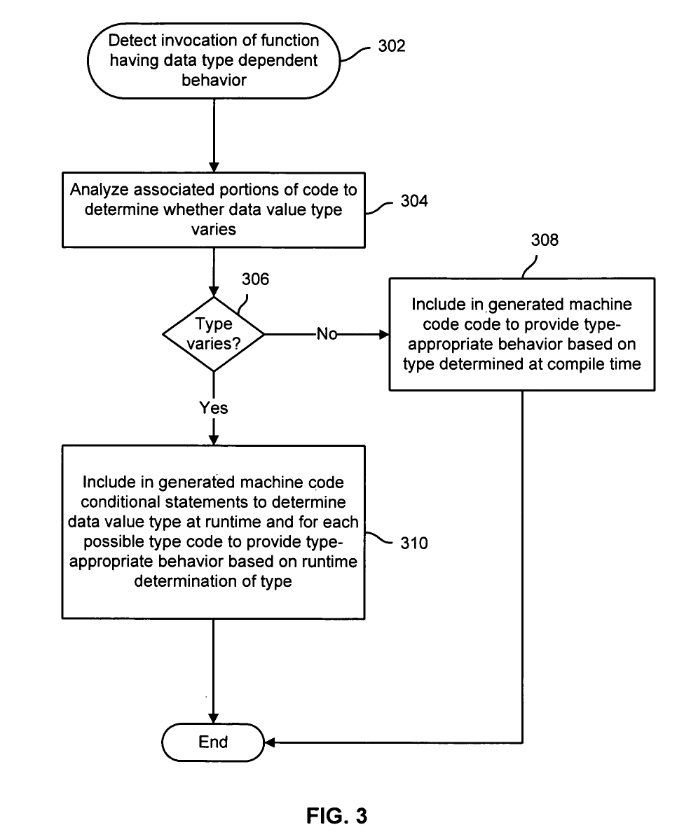

FIG. 3 is a flow diagram illustrating an embodiment of a process for variable type knowledge based call specialization. In various embodiments, the process of FIG. 3 is performed in connection with generating compiled machine code based on JavaScript or other code written in a loosely typed or un-typed programming language that includes one or more operations and/or functions whose behavior varies based on a data type of an argument as determined at runtime. In the example shown, invocation of a function (or operation) having data type dependent behavior in a source programming language, e.g., JavaScript, is detected (302). Associated portions of code are analyzed to determine whether the data type of a variable or other value on which the function (or operation) operates can be determined to be of a type corresponding to one or another of the type specific behaviors of the function (or operation) in the source language, or if instead the data type does or may vary such that an a priori resolution of the data type is not possible (304). If the data type of the variable(s) can be determined (306), machine code is generated to implement only a behavior corresponding to that data type (308). Otherwise, machine code configured to determine the data type at runtime (e.g., conditional statements) and for each possible data type corresponding type-specific behavior for that type as determined at run time, is generated (310).

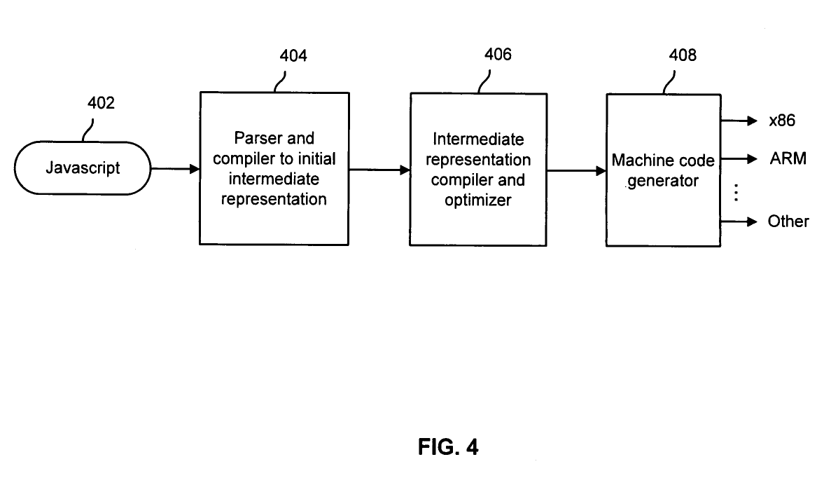

FIG. 4 is a block diagram illustrating an embodiment of a system for compiling JavaScript or other code written in a loosely-typed or un-typed programming language. In the example shown, JavaScript 402 is parsed and an initial intermediate representation of the JavaScript is generated by a parser and initial intermediate representation generator 404. The intermediate representation (e.g., byte code) generated by initial intermediate representation generator 404 is provided to an optimization and second stage compiler 406. In various embodiments, the initial intermediate representation undergoes one or more stages or levels of optimization processing and the optimized initial intermediate representation is further compiled to generate a second stage intermediate representation, such as LLVM IR or another device-independent but relatively low level intermediate representation. The LLVM IR in some embodiments is provided to a machine code generator 408 to generate device-appropriate machine code for one or more devices each having an associated processor architecture, such as x86, ARM, or other, requiring a corresponding processor architecture appropriate machine code. In some embodiments, the LLVM IR or a predecessor intermediate representation thereof includes an encoding of variable data type information which is used in connection with the process of FIG. 3 to determine based on variable data type information embodied in the LLVM IR the data type of variables operated on by a function or operation that exhibits data type-dependent behavior in a source programming language, e.g., JavaScript and based on that determination to include in machine code generated based on the LLVM IR machine code that implements only the behavior corresponding to the determined data type. In this way, functions or operations that have data type-dependent behavior in a source programming language or environment with which source code on which the LLVM IR is based are specialized by generating machine code based on the source code (more immediately the LLVM IR) that exhibits only the behavior associated with a data type that has been determined to be associated with the variable as determined by analyzing the LLVM IR. In some embodiments, in addition to and/or instead of variable type information, an operational structure of the underlying source code, as determined by analyzing the LLVM IR, is used to determine the variable data type for purposes of performing function call specialization as described herein.

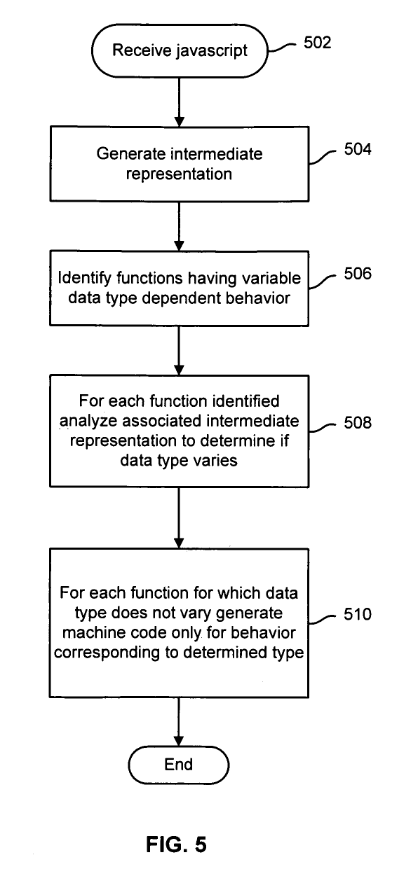

FIG. 5 is a flow diagram illustrating an embodiment of a process for variable type knowledge based call specialization based on analysis of a byte code or other intermediate representation. In the example shown, JavaScript (or other source code) is received (502) and used to generate an intermediate representation (such as bytecode) (504). The intermediate representation is analyzed to identify functions (or operations) that have variable data type-dependent behavior in JavaScript (or another source programming language) (506). For each such function, the associated intermediate representation is analyzed to determine whether a data type of the variable(s) on which the function or operation operates can be determined a priori, that is predicted from static analysis of the code prior to run time to always be of one data type of another (508). For each such case, machine code is generated to implement only a behavior that corresponds to the data type so determined (510).

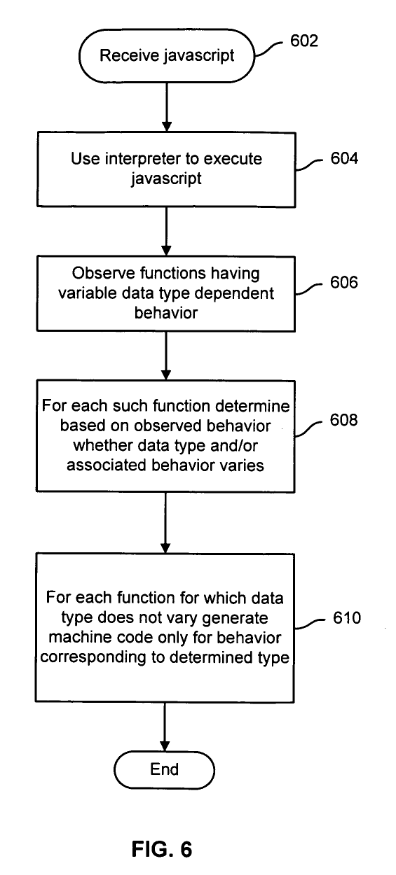

FIG. 6 is a flow diagram illustrating an embodiment of a process for variable type knowledge based call specialization based on observation of source code executed using an interpreter. In the example shown, JavaScript (or other source code) is received (602) and executed using an interpreter (604). The runtime behavior of functions (or operations) that have variable data type-dependent behavior in a source programming language of the interpreted source code is observed (606). For each such function, it is determined whether the variable data type and/or associated behavior varies, or if instead only a behavior corresponding to one particular data type is observed (608). For each function for which the data type of the variables on which it operates is/are determined not to vary, machine code is generated to implement only the observed behavior (or the behavior corresponding to the observed data type, in an embodiment in which the data type is observed directly, as opposed to just the function behavior).

Using the approaches described herein optimized machine code that does not include unneeded and costly conditional statements to determine variable data type at runtime and provide data type-dependent behavior at runtime can be avoided. Instead, where the data type of variables or other arguments can be determined a priori, for example by analyzing source code and/or an intermediate representation thereof, or by observing the behavior of code such as JavaScript as executed by an interpreter, machine code to implement only a behavior corresponding to a predetermined data type is generated, eliminating the need to implement and evaluate at run time conditional statements and the needless generation of machine code to implement behaviors associated with data types that will never be encountered.

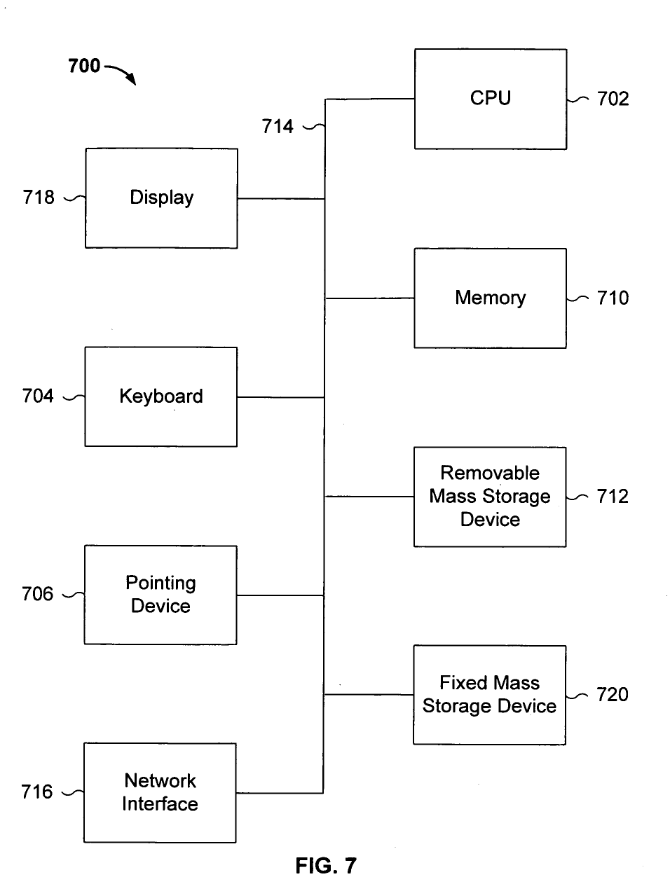

FIG. 7 is a block diagram of a computer system 700 used in some embodiments to perform variable type knowledge based call specialization. FIG. 7 illustrates one embodiment of a general purpose computer system. Other computer system architectures and configurations can be used for carrying out the processing of the present invention. Computer system 700, made up of various subsystems described below, includes at least one microprocessor subsystem (also referred to as a central processing unit, or CPU) 702. That is, CPU 702 can be implemented by a single-chip processor or by multiple processors. In some embodiments CPU 702 is a general purpose digital processor which controls the operation of the computer system 700. Using instructions retrieved from memory 710, the CPU 702 controls the reception and manipulation of input data, and the output and display of data on output devices. In some embodiments, CPU 702 comprises and/or is used to provide the parser & compiler 404, compiler & optimizer 406, and/or machine code generator 408 of FIG. 4 and/or implements the processes of FIGS. 3, 5, and/or 6.

CPU 702 is coupled bi-directionally with memory 710 which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on CPU 702. Also as well known in the art, primary storage typically includes basic operating instructions, program code, data and objects used by the CPU 702 to perform its functions. Primary storage devices 710 may include any suitable computer-readable storage media, described below, depending on whether, for example, data access needs to be bi-directional or uni-directional. CPU 702 can also directly and very rapidly retrieve and store frequently needed data in a cache memory (not shown).

A removable mass storage device 712 provides additional data storage capacity for the computer system 700, and is coupled either bi-directionally (read/write) or uni-directionally (read only) to CPU 702. Storage 712 may also include computer-readable media such as magnetic tape, flash memory, signals embodied on a carrier wave, PC-CARDS, portable mass storage devices, holographic storage devices, and other storage devices. A fixed mass storage 720 can also provide additional data storage capacity. The most common example of mass storage 720 is a hard disk drive. Mass storage 712, 720 generally store additional programming instructions, data, and the like that typically are not in active use by the CPU 702. It will be appreciated that the information retained within mass storage 712, 720 may be incorporated, if needed, in standard fashion as part of primary storage 710 (e.g. RAM) as virtual memory.

In addition to providing CPU 702 access to storage subsystems, bus 714 can be used to provide access other subsystems and devices as well. In the described embodiment, these can include a display monitor 718, a network interface 716, a keyboard 704, and a pointing device 706, as well as an auxiliary input/output device interface, a sound card, speakers, and other subsystems as needed. The pointing device 706 may be a mouse, stylus, track ball, or tablet, and is useful for interacting with a graphical user interface.

The network interface 716 allows CPU 702 to be coupled to another computer, computer network, or telecommunications network using a network connection as shown. Through the network interface 716, it is contemplated that the CPU 702 might receive information, e.g., data objects or program instructions, from another network, or might output information to another network in the course of performing the above-described method steps. Information, often represented as a sequence of instructions to be executed on a CPU, may be received from and outputted to another network, for example, in the form of a computer data signal embodied in a carrier wave. An interface card or similar device and appropriate software implemented by CPU 702 can be used to connect the computer system 700 to an external network and transfer data according to standard protocols. That is, method embodiments of the present invention may execute solely upon CPU 702, or may be performed across a network such as the Internet, intranet networks, or local area networks, in conjunction with a remote CPU that shares a portion of the processing. Additional mass storage devices (not shown) may also be connected to CPU 702 through network interface 716.

An auxiliary I/O device interface (not shown) can be used in conjunction with computer system 700. The auxiliary I/O device interface can include general and customized interfaces that allow the CPU 702 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter.

The computer system shown in FIG. 7 is but an example of a computer system suitable for use with the invention. Other computer systems suitable for use with the invention may include additional or fewer subsystems. In addition, bus 714 is illustrative of any interconnection scheme serving to link the subsystems. Other computer architectures having different configurations of subsystems may also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for processing computer code, comprising:
determining programmatically that a variable that is an argument of a function or operation the behavior of which depends at least in part on a data type of the argument is of a first data type; and
generating programmatically for the function or operation a machine code that implements a first behavior that corresponds to the first data type but not a second behavior that corresponds to a second data type other than the first data type.

2. The method of claim 1 wherein determining programmatically that the variable is of the first data type comprises analyzing a source code with which the machine code is associated to determine that the variable is of the first data type.

3. The method of claim 1 wherein determining programmatically that the variable is of the first data type comprises analyzing an intermediate representation of a source code with which the machine code is associated to determine that the variable is of the first data type.

4. The method of claim 3 wherein the intermediate representation comprises LLVM IR or other byte code.

5. The method of claim 3 further comprising receiving the source code and generating the intermediate representation.

6. The method of claim 3 wherein the intermediate representation exposes to determination by programmatic analysis of the intermediate representation a program structure of the source code.

7. The method of claim 3 wherein the intermediate representation includes a variable type information associated with the argument.

8. The method of claim 1 wherein determining programmatically that the variable is of the first data type comprises using an interpreter to execute a source code with which the machine code is associated and observing that during executing of the source code the function exhibits the first behavior.

9. The method of claim 1 wherein determining programmatically that the variable is of the first data type comprises using an interpreter to execute a source code with which the machine code is associated and observing that during executing of the source code the variable is of the first data type.

10. A system for processing software code, comprising:
a processor; and
a memory coupled with the processor, wherein the memory is configured to provide the processor with instructions which when executed cause the processor to:
receive an indication that a variable that is an argument of a function or operation the behavior of which depends at least in part on a data type of the argument is of a first data type; and
generate for the function or operation a machine code that implements a first behavior that corresponds to the first data type but not a second behavior that corresponds to a second data type other than the first data type.

11. The system of claim 10 wherein the instructions cause the processor to receive the indication at least in part by analyzing an intermediate representation of a source code with which the machine code is associated to determine that the variable is of the first data type.

12. The system of claim 11 wherein the intermediate representation comprises LLVM IR or other byte code.

13. The system of claim 11 wherein the instructions further cause the processor to receive the source code and generating the intermediate representation.

14. The system of claim 11 wherein the intermediate representation exposes to determination by programmatic analysis of the intermediate representation a program structure of the source code.

15. The system of claim 11 wherein the intermediate representation includes a variable type information associated with the argument.

16. The system of claim 10 wherein the instructions cause the processor to receive the indication at least in part by using an interpreter to execute a source code with which the machine code is associated and observing that during executing of the source code the function exhibits the first behavior.

17. The system of claim 10 wherein the instructions cause the processor to receive the indication at least in part by using an interpreter to execute a source code with which the machine code is associated and observing that during executing of the source code the variable is of the first data type.

18. A computer program product for processing software code, the computer program product being embodied in a computer readable storage medium and comprising computer instructions for:
receiving an indication that a variable that is an argument of a function or operation the behavior of which depends at least in part on a data type of the argument is of a first data type; and
generating for the function or operation a machine code that implements a first behavior that corresponds to the first data type but not a second behavior that corresponds to a second data type other than the first data type.

19. The computer program product recited in claim 18 wherein receiving the indication the variable is of the first data type comprises analyzing an intermediate representation of a source code with which the machine code is associated to determine that the variable is of the first data type.

20. The computer program product recited in claim 18 wherein receiving the indication the variable is of the first data type comprises using an interpreter to execute a source code with which the machine code is associated and observing that during execution of the source code the function exhibits the first behavior.

21. A system for processing software code, comprising:
means for receiving an indication that a variable that is an argument of a function or operation the behavior of which depends at least in part on a data type of the argument is of a first data type; and
means for generating for the function or operation a machine code that implements a first behavior that corresponds to the first data type but not a second behavior that corresponds to a second data type other than the first data type.
